(19) United States
(12) Patent Application Publication
(10) Pub. No.: US 2015/0369144 A1
(43) Pub. Date: Dec. 24, 2015

(54) CONTROL APPARATUS FOR VEHICLE

(71) Applicant: TOYOTA JIDOSHA KABUSHIKI KAISHA, Toyota-shi (JP)

(72) Inventors: Kenji ITAGAKI, Suntou-gun (JP); Yoshihito KANNO, Numazu-shi (JP); Gohki KINOSHITA, Isehara-shi (JP); Hiroki MORITA, Hiratsuka-shi (JP); Daisuke IZUOKA, Susono-shi (JP)

(73) Assignee: TOYOTA JIDOSHA KABUSHIKI KAISHA, Toyota-shi (JP)

(21) Appl. No.: 14/743,187

(22) Filed: Jun. 18, 2015

(30) Foreign Application Priority Data
Jun. 20, 2014 (JP) 2014-127210

(51) Int. Cl. F02D 29/02; B60W 20/00

(52) U.S. Cl. CPC F02D 29/02; B60W 20/10; B60W 2540/10; B60W 2510/0685; B60W 2710/0677; B60W 2710/0666; Y10S 903/905

(57) ABSTRACT

A control apparatus for a vehicle is provided. The vehicle includes an engine and a transmission. The transmission is configured to continuously change an engine operating point that is defined by a rotational speed of the engine and a torque of the engine. The control apparatus includes an ECU. The ECU is configured to, when a target engine required power increases in response to a reacceleration operation, set the rotational speed and the torque so as to reach a power of the engine to the target engine required power while holding the rotational speed equal to or higher than the rotational speed at a time of the reacceleration operation. The ECU is configured to control the engine operating point based on the set rotational speed and the set torque.

### INCORPORATION BY REFERENCE

The disclosure of Japanese Patent Application No. 2014-127210 filed on Jun. 20, 2014 including the specification, drawings and abstract is incorporated herein by reference in its entirety.

### BACKGROUND OF THE INVENTION

1. Field of the Invention

The invention relates to a control apparatus for a vehicle. This control apparatus is applied to a vehicle whose engine operating point can be continuously changed, such as a hybrid vehicle that is equipped with a differential mechanism to which an engine and a motor-generator are coupled, or the like.

2. Description of Related Art

As a control apparatus for a hybrid vehicle, there is known an apparatus that controls the engine operating point along an optimal fuel economy curve that determines an upper-limit engine torque at the time of acceleration (see Japanese Patent Application Publication No. 2010-47127 (JP 2010-47127 A)). Moreover, the related art documents associated with the invention include Japanese Patent Application Publication No. 2006-217750 (JP 2006-217750 A), Japanese Patent Application Publication No. 2000-87774 (JP 2000-87774 A), and Japanese Patent Application Publication No. 2008-195088 (JP 2008-195088 A).

### SUMMARY OF THE INVENTION

The control apparatus of Japanese Patent Application Publication No. 2010-47127 (JP 2010-47127 A) raises the engine power by reducing the engine rotational speed along the optimal fuel economy curve with a view to giving priority to fuel economy and then raising the engine rotational speed again when reacceleration operation is performed by returning and then depressing an accelerator pedal. However, with this control apparatus, the engine rotational speed is temporarily reduced in response to reacceleration operation. Therefore, the engine rotational speed may deviate from a range ensuring an inertia supercharging effect in the case of a naturally aspirated engine. In such a case, the acceleration responsiveness to reacceleration operation deteriorates. Besides, in the case of an engine that is provided with a turbocharger, a delay in supercharging results from a decrease in turbine rotational speed caused by a temporary decrease in engine rotational speed, so the acceleration responsiveness to reacceleration operation deteriorates.

The invention provides a control apparatus for a vehicle that can restrain the acceleration responsiveness to reacceleration operation from deteriorating.

A control apparatus for a vehicle according to one aspect of the invention is provided. The vehicle includes an engine and a transmission. The transmission is configured to continuously change an engine operating point that is defined by a rotational speed of the engine and a torque of the engine. The control apparatus includes an ECU. The ECU is configured to, when a target engine required power increases in response to a reacceleration operation, set the rotational speed and the torque so as to reach a power of the engine to the target engine required power while holding the rotational speed equal to or higher than the rotational speed at a time of the reacceleration operation. The ECU is configured to control the engine operating point based on the set rotational speed and the set torque.

According to this aspect of the invention, the engine operating point is controlled without reducing the rotational speed in response to reacceleration operation. Therefore, the rotational speed is unlikely to deviate from a range ensuring an inertia supercharging effect in the case of a naturally aspirated engine, and a delay in supercharging is suppressed without causing a decrease in turbine rotational speed in the case of an engine equipped with a turbocharger. Thus, the acceleration responsiveness to reacceleration operation can be restrained from deteriorating.

In the aforementioned aspect of the invention, the ECU may be configured to control the engine operating point to an upper-limit engine torque of the engine along an iso-power line that is equal to the target engine required power, when the power of the engine reaches the target engine required power before the engine operating point reaches the upper-limit engine torque. According to this aspect of the invention, the engine operating point is controlled along the iso-power line upon reaching the target engine required power. Therefore, the engine torque can be increased to the upper-limit engine torque while maintaining the target engine required power.

In the aforementioned aspect of the invention, the ECU may be configured to set a target rotational speed of the engine operating point determined by the upper-limit engine torque and the target engine required power. The ECU may be configured to control the engine operating point so as to increase the rotational speed as the power of the engine increases, when the target rotational speed is higher than the rotational speed at the time of the reacceleration operation. According to this aspect of the invention, the engine operating point is controlled so as to increase the rotational speed as the power of the engine increases. Thus, the acceleration responsiveness is higher than in the case where the rotational speed is held equal to the rotational speed at the time of reacceleration operation until the power of the engine is reached to the target engine required power.

As described hitherto, according to each of the aforementioned aspects of the invention, the engine operating point is controlled without reducing the rotational speed in response to reacceleration operation. Therefore, the rotational speed is unlikely to deviate from the range ensuring an inertia supercharging effect in the case of a naturally aspirated engine, and a delay in supercharging is suppressed without causing a decrease in turbine rotational speed in the case of an engine equipped with a turbocharger. Thus, the acceleration responsiveness to reacceleration operation can be restrained from deteriorating.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing an overall configuration of a vehicle to which a control apparatus according to the first embodiment of the invention is applied;

FIG. 2 is a time chart showing changes in engine rotational speed and engine required power with time;

FIG. 3 is a view showing changes in engine operating point from the performance of reacceleration operation to the attainment of a target point by the engine operating point;

FIG. 4 is a view showing changes in engine operating point in the case where the engine operating point has reached an optimal fuel economy curve as an upper-limit torque before reaching a target engine required power;

FIG. 5 is a flowchart showing an example of a main routine according to the first embodiment of the invention;

FIG. 6 is a flowchart showing an example of driving force priority control according to the first embodiment of the invention defined in FIG. 5;

FIG. 7 is a view showing changes in operating point in the case where driving force priority control according to the second embodiment of the invention is executed;

FIG. 8 is a flowchart showing an example of driving force priority control according to the second embodiment of the invention defined in FIG. 5; and

FIG. 9 is a flowchart showing an example of operating point control defined in FIG. 8.

### DETAILED DESCRIPTION OF EMBODIMENTS

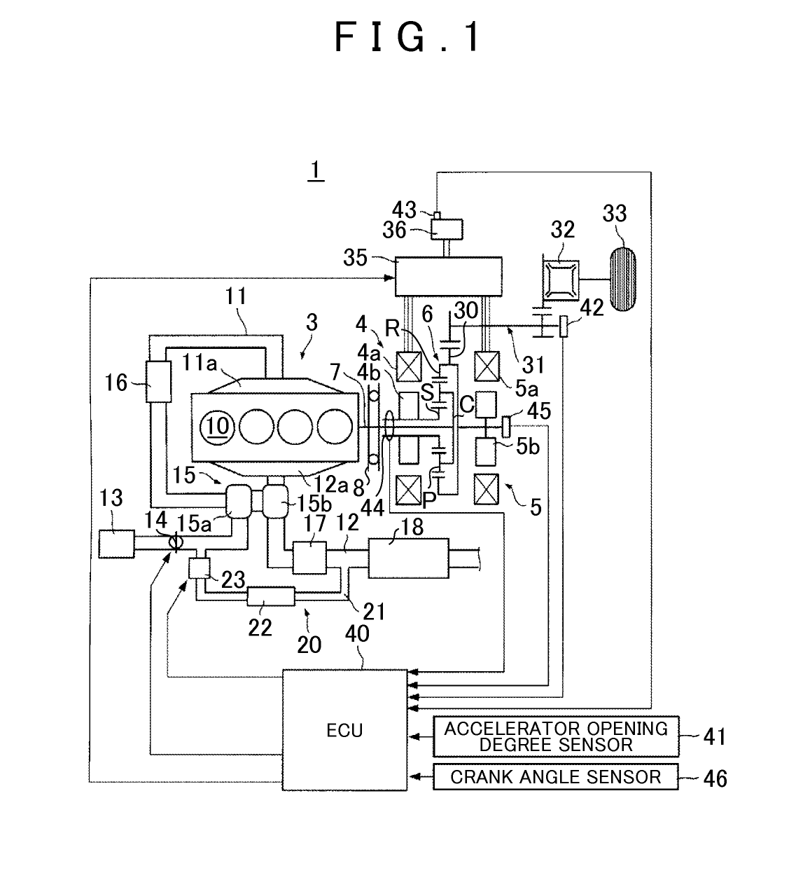

First of all, the first embodiment of the invention will be described. As shown in FIG. 1, a vehicle 1 is configured as a hybrid vehicle that combines a plurality of power sources. The vehicle 1 is equipped with an engine 3 and two motor-generators 4 and 5 as running power sources. The engine 3 is an in-line four-cylinder internal combustion engine that is equipped with four cylinders 10.

An intake passage 11 and an exhaust passage 12 are connected to the respective cylinders 10 of the engine 3. The intake passage 11 includes an intake manifold 11a that distributes intake air to the respective cylinders 10. The exhaust passage 12 includes an exhaust manifold 12a that aggregates exhaust gas in the respective cylinders 10. The intake passage 11 is provided with an air cleaner 13 for filtering air, a throttle valve 14 that can adjust the flow rate of air, a compressor 15a of a turbocharger 15, and an intercooler 16. The exhaust passage 12 is provided with a turbine 15b of the turbocharger 15, a start catalyst 17 that purifies exhaust gas mainly in a cold state, and an NOx catalyst 18 that purifies noxious components in exhaust gas. The NOx catalyst 18 is a well-known occlusion-reduction type NOx catalyst.

The engine 3 is provided with an EGR device 20 that recirculates part of exhaust gas to an intake system. The EGR device 20 is equipped with an EGR passage 21 that joins the exhaust passage 12 and the intake passage 11 to each other, an EGR cooler 22 that cools the exhaust gas introduced to the EGR passage 21, and an EGR valve 23 that adjusts the flow rate of EGR gas. The EGR passage 21 is connected at one end thereof on an exhaust side to the exhaust passage 12 between the start catalyst 17 and the NOx catalyst 18, and is connected at the other end thereof on an intake side to the intake passage 11 between the throttle valve 14 and the compressor 15a of the turbocharger 15.

The engine 3 and the first motor-generator 4 are connected to a power split mechanism 6. An output of the power split mechanism 6 is transmitted to an output gear 30. The output gear 30 and the second motor-generator 5 are coupled to each other, and rotate integrally with each other. The power output from the output gear 30 is transmitted to a driving wheel 33 via a reduction gear 31 and a differential gear 32. The first motor-generator 4 has a stator 4a and a rotor 4b. The first motor-generator 4 functions as a generator that generates electricity upon receiving the power of the engine 3 split by the power split mechanism 6, and also functions as an electric motor that is driven by an AC electric power. By the same token, the second motor-generator 5 has a stator 5a and a rotor 5b, and functions as an electric motor and a generator respectively. The respective motor-generators 4 and 5 are connected to a battery 36 via a motor control device 35. The motor control device 35 converts the electric power generated by the respective motor-generators 4 and 5 into a DC electric power to store this DC electric power into the battery 36, and converts the electric power of the battery 36 into an AC electric power to supply the respective motor-generators 4 and 5 therewith.

The power split mechanism 6 is configured as a single pinion-type planetary gear mechanism, and has a sun gear S, a ring gear R, and a planetary carrier C that holds a pinion P meshing with these gears S and R in such a state that the pinion P can rotate around itself and rotate around the planetary carrier C. The sun gear S is coupled to the rotor 4b of the first motor-generator 4, the ring gear R is coupled to the output gear 30, and the planetary carrier C is coupled to a crankshaft 7 of the engine 3. The engine 3 and the first motor-generator 4 are connected to respective rotary elements of the power split mechanism 6 as a differential mechanism. Therefore, the engine operating point of the engine 3, which is defined by the engine rotational speed and the engine torque, can be continuously changed by controlling the first motor-generator 4. Accordingly, a combination of the power split mechanism 6 and the first motor-generator 4 is equivalent to a speed change mechanism according to the invention. Incidentally, there is a damper 8 between the crankshaft 7 and the planetary carrier C. The damper 8 absorbs torque fluctuations of the engine 3.

The vehicle 1 is controlled by an electronic control unit (an ECU) 40. The ECU 40 executes various kinds of control for the engine 3 and the respective motor-generators 4 and 5. The main control executed by the ECU 40 in association with the invention will be described hereinafter. Signals of a multitude of sensors are input to the ECU 40. However, as those associated with the invention, respective signals of an accelerator opening degree sensor 41 that outputs a signal corresponding to a depression amount of an accelerator pedal (not shown) (an accelerator opening degree), a vehicle speed sensor 42 that outputs a signal corresponding to a speed of the vehicle 1 (a vehicle speed), an SOC sensor 43 that outputs a signal corresponding to a storage ratio of the battery 36, a first resolver 44 that outputs a signal corresponding to a motor rotational speed of the first motor-generator 4, a second resolver 45 that outputs a signal corresponding to a motor rotational speed of the second motor-generator 5, and a crank angle sensor 46 that outputs a signal corresponding to an engine rotational speed of the engine 3 are input to the ECU 40.

The ECU 40 calculates a required power required by a driver with reference to the output signal of the accelerator opening degree sensor 41 and the output signal of the vehicle speed sensor 42, and controls the vehicle 1 while making changeovers among various modes in such a manner as to optimize the system efficiency for the required power. For example, in a low-load range in which the thermal efficiency of the engine 3 decreases, an EV mode in which the combustion of the engine 3 is stopped and the second motor-generator 5 is driven is selected. Besides, when the storage ratio of the battery 36 turns out to be insufficient with reference to the signal of the SOC sensor 43, an engine running mode is selected to execute control for restraining the battery 36 from consuming electric power. Furthermore, the engine 3 alone cannot secure a sufficient torque, a hybrid mode in which the engine 3 and the second motor-generator 5 serve as driving sources for running is selected. When the hybrid mode is selected, the required power is output through summation of an engine power of the engine 3 and a motor power of the second motor-generator 5. As is well known, in a scene in which importance is attached to fuel economy, the engine 3 is controlled such that the engine operating point moves in principle along an optimal fuel economy curve that is set in advance so as to optimize the thermal efficiency. Incidentally, the engine operating point is defined by the engine rotational speed and the engine torque.

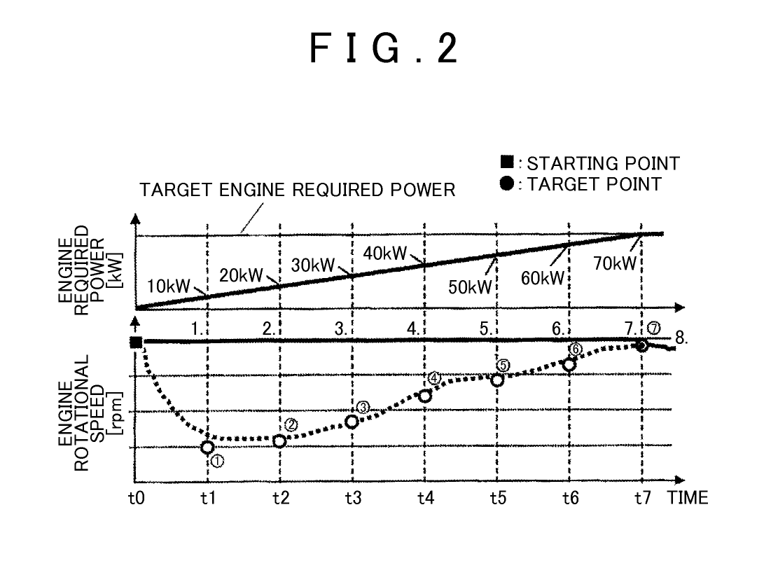

The control according to the first embodiment of the invention is characterized by the control contents at the time of reacceleration operation, namely, at the time when the accelerator pedal of the vehicle 1 is depressed again after being released. Before describing a concrete processing executed by the ECU 40, the outline of the control according to the first embodiment of the invention will be described in conjunction with a comparative example, with reference to an example of a control result shown in FIGS. 2 to 4.

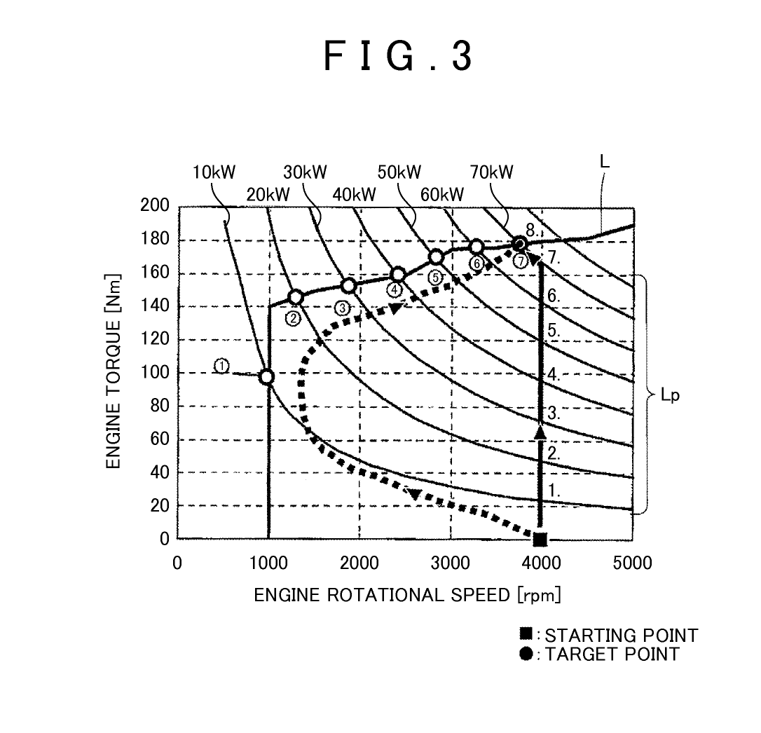

FIG. 2 shows changes in the engine rotational speed and the engine required power with time from the performance of reacceleration operation at the time when the engine rotational speed is 4000 rpm to the attainment of a target point by the engine operating point. FIG. 3 shows changes in the engine operating point in this situation. Broken curves of FIGS. 2 and 3 represent the comparative example.

As shown in FIG. 2, when reacceleration operation is performed at a time t0, a target engine required power is set in accordance with a change in the accelerator opening degree, and the engine required power rises. In the illustrated case, the target engine required power is set to 70 kw. Then, an engine required power at each time is set such that the engine required power increases at a predetermined rate from the time t0 and reaches the target engine required power at a time t7. In the case of the control according to the present embodiment of the invention indicated by a solid line, the engine rotational speed is held equal to 4000 rpm, which is the engine rotational speed at the time of reacceleration operation, until the target engine required power is reached.

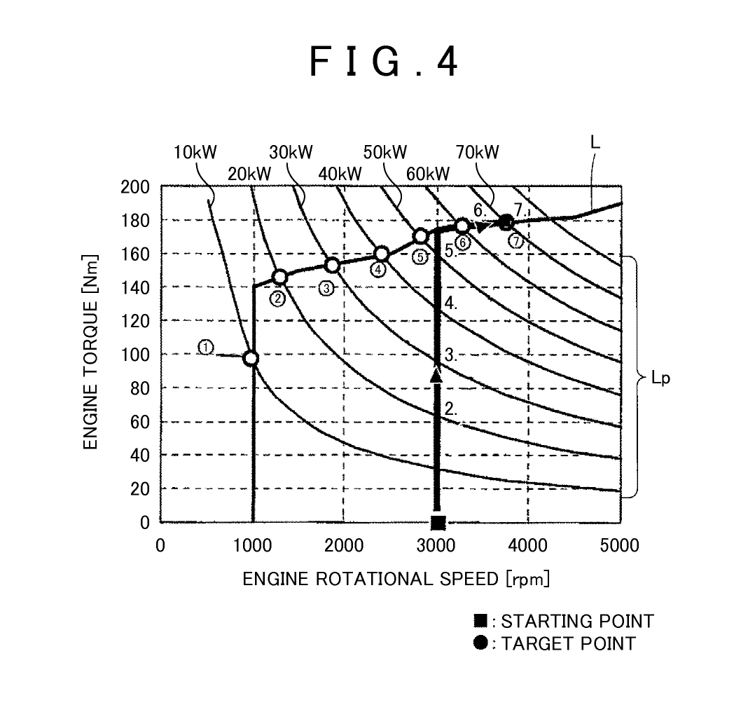

Then, as indicated by a solid line of FIG. 3, the engine operating point moves to an iso-power line Lp of 70 kw, which is the target engine required power, such that the engine torque gradually increases from the time t1 to the time t7 while the engine rotational speed is held constant. In the illustrated case, the engine operating point has reached the target engine required power before reaching an optimal fuel economy curve L of FIG. 3 that determines an upper-limit engine torque. Therefore, the engine operating point moves to the optimal fuel economy curve L along the iso-power line Lp of 70 kw, which is the target engine required power, and reaches the target point. Incidentally, FIG. 4 shows a case where the engine operating point has reached the optimal fuel economy curve L as the upper-limit engine torque before reaching the target engine required power. In this case, the engine torque is increased with the engine rotational speed held equal to 3000 rpm, which is the engine rotational speed at the time of reacceleration operation, and the engine operating point is moved to the target point along the optimal fuel economy curve L after reaching the optimal fuel economy curve L.

On the other hand, in the case of the comparative example indicated by the broken curves in FIGS. 2 and 3, the engine operating point is moved to the target point by temporarily reducing the engine rotational speed after reacceleration operation at the time t0 such that the engine operating point moves along the optimal fuel economy curve L and then raising the engine torque while gradually increasing the engine rotational speed. In this manner, in the case of the comparative example, the engine rotational speed temporarily decreases until the engine operating point reaches the target point from a starting point. Therefore, the turbine rotational speed of the turbocharger 15 falls as the engine rotational speed decreases. Therefore, a delay in the supercharging of the engine 3 is caused, so the acceleration responsiveness may deteriorate. In contrast, the control according to the present embodiment of the invention ensures that the engine operating point reaches the target point after the engine rotational speed is held equal to the engine rotational speed at the time of reacceleration operation by the time the engine operating point reaches the target engine required power from the starting point. Therefore, the turbine rotational speed does not fall in response to reacceleration operation, and a delay in the supercharging of the engine 3 is avoided. As a result, the acceleration responsiveness is restrained from deteriorating.

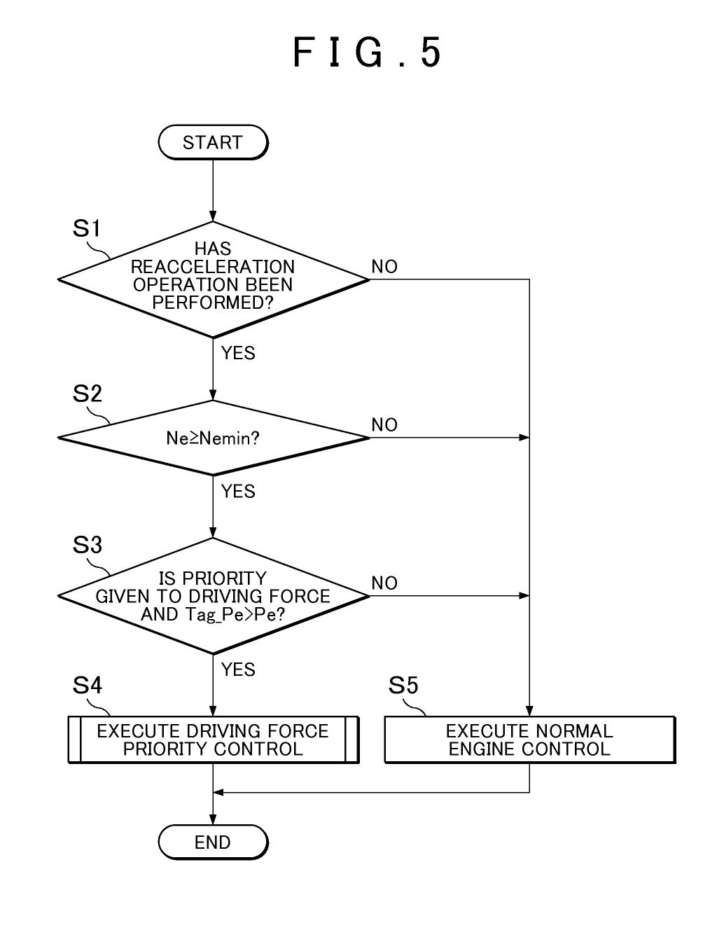

Next, a concrete processing that is executed by the ECU 40 to realize the aforementioned control will be described. As shown in FIG. 5, in step S1, the ECU 40 determines whether or not reacceleration operation has been performed. For example, the ECU 40 refers to a signal of the accelerator opening degree sensor 41, and determines that reacceleration operation has been performed when the accelerator opening degree has increased from a state of being equal to or smaller than 10%, when the accelerator opening degree has become larger than 0% from a state of being 0% with the accelerator pedal returned, etc. If reacceleration operation has been performed, the ECU 40 proceeds to step S2. Otherwise, the ECU 40 proceeds to step S5 to execute normal engine control for operating the engine operating point along the optimal fuel economy curve (see the broken curve of FIG. 3).

In step S2, the ECU 40 refers to the signal of the crank angle sensor 46, acquires an engine rotational speed Ne, and determines whether or not the engine rotational speed Ne is equal to or higher than a predetermined minimum rotational speed Nemin. The minimum rotational speed Nemin is appropriately set as an execution condition of the aforementioned present control, and is set to, for example, 1000 rpm. If the engine rotational speed Ne is equal to or higher than the minimum rotational speed Nemin, the ECU 40 proceeds to step S3. Otherwise, the ECU 40 proceeds to step S5 to execute normal engine control.

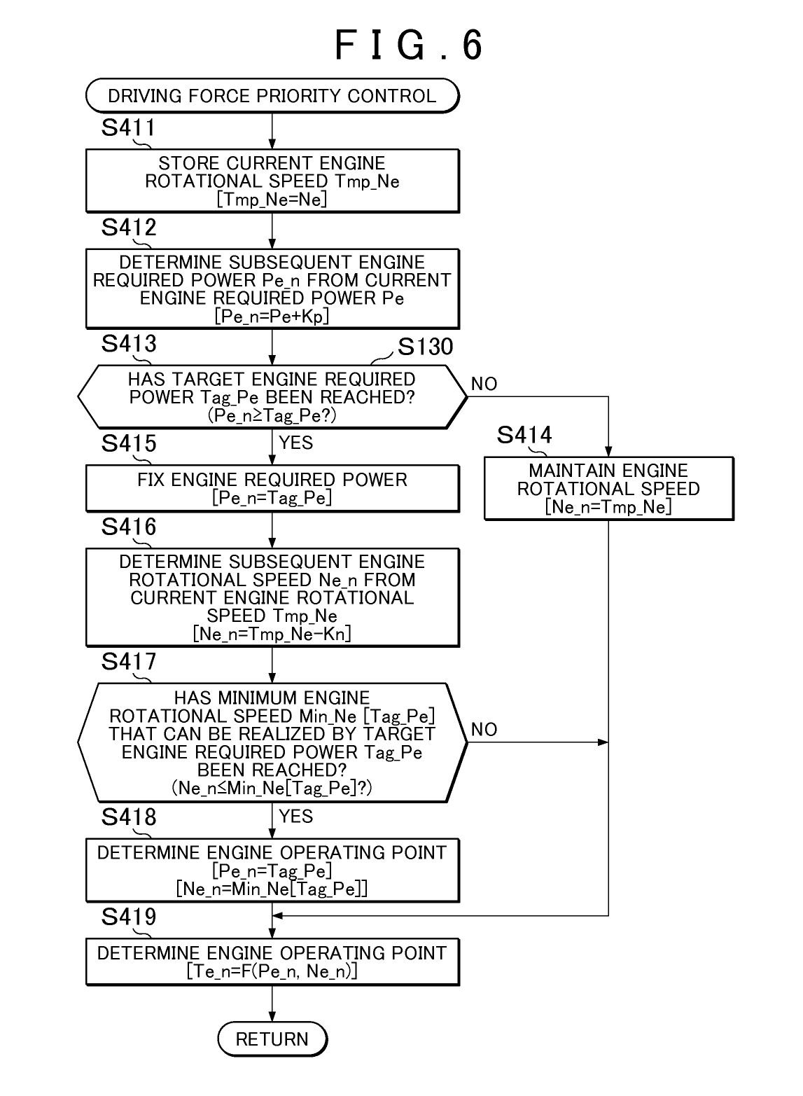

In step S3, the ECU 40 determines whether or not there is established an operating condition under which priority is given to the driving force and a target engine required power Tag_Pa is larger than a current engine required power Pe. The operating condition under which priority is given to the driving force is, for example, a condition that the accelerator opening degree be equal to or larger than 90%, or a condition that a sport mode be selected by turning ON a sport mode switch (not shown) in the case where the vehicle 1 is configured to allow the driver to select a sport mode in which the kinetic performance is higher than in a normal mode, as a running mode of the vehicle 1, by operating the sport mode switch. The target engine required power Tag_Pa and the engine required power Pe are calculated based on operating parameters such as an accelerator opening degree, a vehicle speed and the like, through the execution of a control routine (not shown). However, since the control routine is known, detailed description thereof will be omitted. If a positive determination is made in step S3, the ECU 40 proceeds to step S4 to execute driving force priority control shown in FIG. 6. If a negative determination is made in step S3, the ECU 40 proceeds to step S5 to execute normal engine control.

As shown in FIG. 6, in step S411, the ECU 40 stores the engine rotational speed Ne acquired in step S2 of FIG. 5, as a current engine rotational speed Tmp_Ne. In step S412, the ECU 40 determines a subsequent engine required power Pe_n from the current engine required power Pe. In this case, as described with reference to FIG. 2, the ECU 40 determines a value obtained by adding a constant Kp to the current engine required power Pe such that the engine required power increases at a certain rate, as the subsequent engine required power Pe_n. Incidentally, the terms such as the subsequent engine required power Pe_n and the like mean operation amounts applied to a controlled object in a currently executed routine.

In step S413, the ECU 40 determines whether or not the engine operating point has reached the target engine required power Tag_Pe by comparing the engine required power Pe_n determined in step S412 with the target engine required power Tag_Pe. If the engine operating point has not reached the target engine required power Tag_Pe, the ECU 40 proceeds to step S414 to hold the engine rotational speed constant as described with reference to FIG. 2. That is, the ECU 40 adopts the subsequent engine rotational speed Ne_n as the current engine rotational speed Tmp_Ne stored in step S411. Then, the ECU 40 proceeds to step S419.

On the other hand, if the engine operating point has reached the target engine required power Tag_Pe, the ECU 40 proceeds to step S415 to fix the subsequent engine required power Pe_n as the target engine required power Tag_Pe. In step S416, the ECU 40 determines a subsequent engine rotational speed Ne_n from the current engine rotational speed Tmp_Ne. In the case of FIGS. 2 and 3, the ECU 40 determines a value obtained by subtracting a constant Kn from the current engine rotational speed Tmp_Ne as the subsequent engine rotational speed Ne_n, such that the engine rotational speed decreases at a certain rate.

In step S417, the ECU 40 determines whether or not the engine operating point has reached a minimum engine rotational speed Min Ne [Tag_Pe] that can be realized by the target engine required power Tag_Pe on the optimal fuel economy curve L that determines the upper-limit engine torque. In this case, the ECU 40 determines whether or not the engine operating point has reached the minimum engine rotational speed Min Ne [Tag_Pe] by confirming whether or not the engine rotational speed Ne_n determined in step 5416 has become equal to or lower than the minimum engine rotational speed Min Ne [Tag_Pe]. If the engine operating point has reached the minimum engine rotational speed Min Ne [Tag_Pe], the engine operating point is located at an intersection point of an iso-power line of the target engine required power Tag_Pe and an optimal fuel economy curve. If the engine operating point has reached the minimum engine rotational speed Min_Ne [Tag_Pe], the ECU 40 proceeds to step S418 to determine the engine operating point. Otherwise, the ECU 40 proceeds to step S419.

In step S419, the ECU 40 determines the engine operating point by setting a subsequent engine torque Te_n based on the engine required power Pe_n and the engine rotational speed Ne_n that have been determined in the aforementioned process. Then, the ECU 40 operates the first motor-generator 4 such that the engine 3 is operated at the engine operating point determined in step S419. Incidentally, a function F(a, b) that is used to set the engine torque Te_n is defined by an expression 1 shown below.

F(a,b)=*60*1000/(2π*b) 1

The engine rotational speed is held equal to the engine rotational speed at the time of reacceleration operation before the engine operating point reaches the target engine required power as described with reference to FIG. 2, through the execution of the control routines of FIGS. 5 and 6. Therefore, the turbine rotational speed does not fall in response to reacceleration operation, and a delay in the supercharging of the engine 3 is avoided. As a result, the acceleration responsiveness is restrained from deteriorating. Then, after the engine operating point has reached the target engine required power, the engine rotational speed decreases at a certain rate while the engine required power is held equal to the target engine required power, through the processes of steps S415 to S418 of FIG. 6. Therefore, the engine operating point moves along an iso-power line that is equal to the target engine required power. The ECU 40 functions as engine torque setting means and operating point control means according to the invention, by executing the control routines of FIGS. 5 and 6.

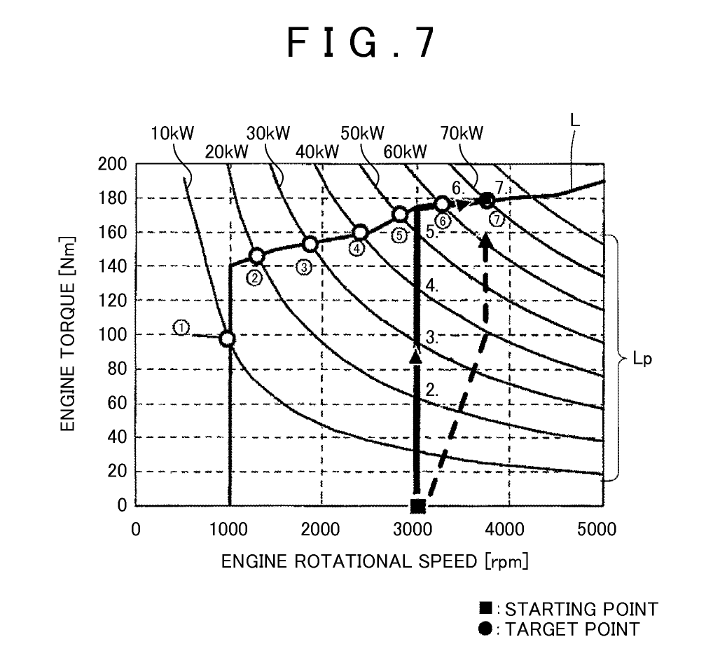

Next, the second embodiment of the invention will be described with reference to FIGS. 7 to 9. The second embodiment of the invention is identical to the first embodiment of the invention except in the contents of driving force priority control defined in FIG. 5. Therefore, the main routine of FIG. 5, the physical configuration of the vehicle of FIG. 1, and the like, which are common to the first embodiment of the invention, will not be described below.

As indicated by a broken curve in FIG. 7, the control according to the present embodiment of the invention is designed to control the engine operating point such that the rotational speed increases as the engine power increases, in the case where a target rotational speed (about 3800 rpm) that is determined by the optimal fuel economy curve L determining the upper-limit engine torque and the target engine required power is higher than the rotational speed (3000 rpm) at the time of reacceleration operation. Therefore, before the engine operating point reaches the target engine required power, the engine rotational speed is held higher than the engine rotational speed at the time of reacceleration operation as indicated by the broken curve in FIG. 7. Accordingly, the acceleration responsiveness is higher than in the first embodiment of the invention in which the engine rotational speed is held equal to the engine rotational speed at the time of reacceleration operation until the engine power is reached to the target engine required power.

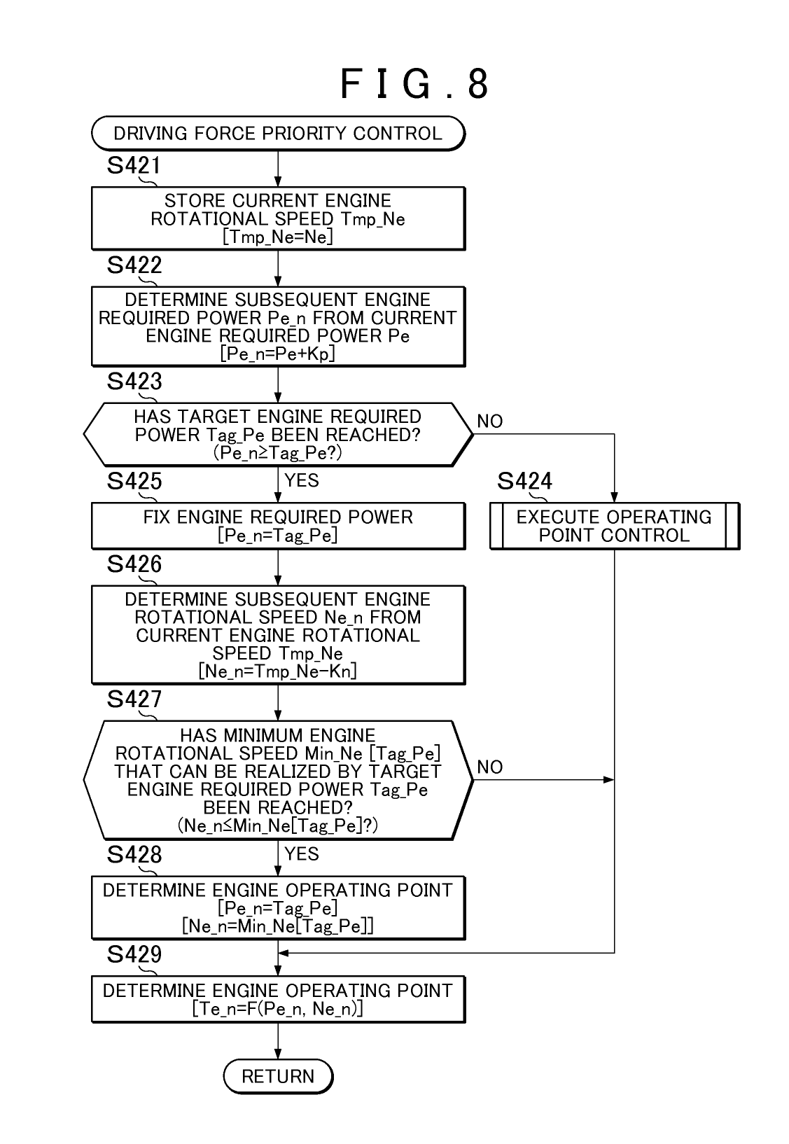

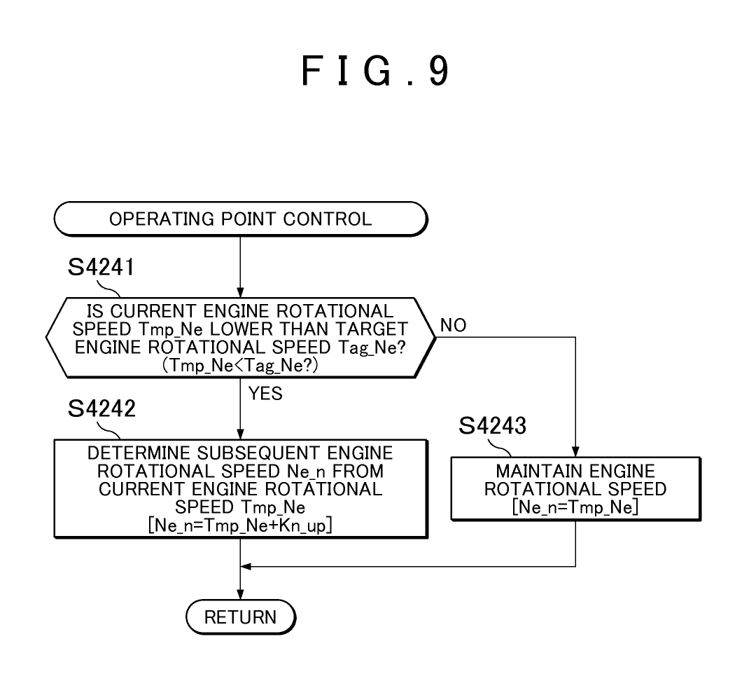

Driving force priority control according to the present embodiment of the invention is executed based on control routines shown in FIGS. 8 and 9. As is apparent from a comparison between FIGS. 6 and 8, the control routine of FIG. 8 is identical to the control routine of FIG. 6 except in engine operating point control defined in step S424. Accordingly, the steps common to FIG. 6, namely, steps S421 to S423 and steps S425 to S429 will not be described below.

If it is determined in step S423 of FIG. 8 that the target engine required power Tag_Pe has not been reached, operating point control of FIG. 9 as defined in step S424 is executed. As shown in FIG. 9, in step S4241, the ECU 40 determines whether or not the current engine rotational speed Tmp_Ne stored in step S421 of FIG. 8 is lower than the target engine rotational speed Tag_Ne. The target engine rotational speed Tag_Ne is determined by the target engine required power Tag_Pe and the upper-limit engine torque. That is, the target engine rotational speed Tag_Ne is an engine rotational speed at an intersection point (a target point) of the iso-power line Lp of the target engine required power Tag_Pe and the optimal fuel economy curve L determining the upper-limit engine torque, as shown in FIG. 7. If the current engine rotational speed Tmp_Ne is lower than the target engine rotational speed Tag_Ne, the ECU 40 proceeds to step S4242. Otherwise, the ECU 40 proceeds to step S4243.

In step S4242, the ECU 40 determines the subsequent engine rotational speed Ne_n from the current engine rotational speed Tmp_Ne. In this case, the ECU 40 determines a value obtained by adding a constant Kn_up to the current engine rotational speed Tmp_Ne as the subsequent engine rotational speed Ne_n such that the engine rotational speed increases at a certain rate as the engine power increases, and then ends the processing. Incidentally, the increasing of the engine rotational speed at a certain rate as the engine power increases is nothing more than an example. For instance, the rate may be changed in accordance with the deviation between the target engine rotational speed Tag_N and the current engine rotational speed Tmp_Ne.

In step S4243, the ECU 40 holds the engine rotational speed constant. That is, the ECU 40 sets the subsequent engine rotational speed Ne_n equal to the current engine rotational speed Tmp_Ne stored in step S411, and then ends the processing.

According to the control routines of FIGS. 8 and 9, while the current engine rotational speed Tmp_Ne is lower than the target engine rotational speed Tag Ne, the engine rotational speed increases as the engine power increases. Therefore, the acceleration responsiveness is higher than in the case where the engine rotational speed is held equal to the engine rotational speed at the time of reacceleration operation as in the first embodiment of the invention. The ECU 40 functions as engine torque setting means and operating point control means according to the invention, by executing the control routines of FIGS. 5, 8, and 9.

The invention is not limited to the aforementioned first and second embodiments thereof, but can be carried out in various modes within the range of the gist of thereof In each of the aforementioned embodiments of the invention, the invention is applied to the engine equipped with the turbocharger. However, the invention is also applicable to a naturally aspirated engine. Besides, the configuration of the hybrid vehicle is not limited to that of FIG. 1, as long as the operating point of the engine can be arbitrarily controlled by operating the motor-generators that are coupled to the differential mechanism. Furthermore, the invention is applicable not only to such a hybrid vehicle but also to a vehicle that is equipped with a speed change mechanism that can continuously change the engine operating point. For example, a vehicle that has an engine as the only running power source and driving wheels to which the output of the engine is transmitted via a continuously variable transmission allows the engine operating point to be continuously changed. Accordingly, the control apparatus according to the invention is also applicable to a vehicle that is equipped with this continuously variable transmission. In this case, the continuously variable transmission is equivalent to the speed change mechanism according to the invention.

What is claimed is:

1. A control apparatus for a vehicle, the vehicle including an engine and a transmission, the transmission configured to continuously change an engine operating point that is defined by a rotational speed of the engine and a torque of the engine, the control apparatus comprising:
an ECU configured to, when a target engine required power increases in response to a reacceleration operation, set the rotational speed and the torque so as to reach a power of the engine to the target engine required power while holding the rotational speed equal to or higher than the rotational speed at a time of the reacceleration operation, the ECU being configured to control the engine operating point based on the set rotational speed and the set torque.

2. The control apparatus according to claim 1, wherein
the ECU is configured to control the engine operating point to an upper-limit engine torque of the engine along an iso-power line that is equal to the target engine required power, when the power of the engine reaches the target engine required power before the engine operating point reaches the upper-limit engine torque.

3. The control apparatus according to claim 1, wherein
the ECU is configured to set a target rotational speed of the engine operating point determined by an upper-limit engine torque and the target engine required power,
the ECU is configured to control the engine operating point so as to increase the rotational speed as the power of the engine increases, when the target rotational speed is higher than the rotational speed at the time of the reacceleration operation.
